(19) United States
(12) Patent Application Publication
(10) Pub. No.: US 2002/0061179 A1
(43) Pub. Date: May 23, 2002

(54) Variable optical attenuator

(76) Inventors: Masahito Morimoto, Tokyo (JP); Kouki Sato, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/969,258

(22) Filed: Oct. 2, 2001

(30) Foreign Application Priority Data
Oct. 4, 2000 (JP) 2000-305061

(51) Int. Cl. G02B 6/26

(52) U.S. Cl. 385/140

(57) ABSTRACT

A variable optical attenuator comprising one or more sheets of shutter plates provided between optical components arranged at opposite positions with a space therebetween and capable of shuttering al least one of light propagating between the optical components and a moving device for moving the shutter plate in a direction crossing a light path for the light. An edge section of said at least one shutter plate has a form adapted to reduction of the dependency of an optical attenuation rate on a wavelength.

### FIELD OF THE INVENTION

The present invention relates to a variable optical attenuator used for attenuating light in optical communications.

### BACKGROUND OF THE INVENTION

At present, in association with rapid popularization of wavelength division multiplexing communication, optical amplifiers 31 are provided at relay positions of a transmission line 30 for wavelength multiplex light respectively like in, for instance, the wavelength division multiplexing communication system shown in FIG. 9, and the wavelength division multiplexing communication light is amplified by the respective optical amplifiers 31. When wavelength division multiplexing communication light is transmitted amplifying the light with a plurality of optical amplifiers 31 like in this wavelength division multiplexing communication system, wavelength division multiplexing communication over a long distance can be performed.

In the wavelength division multiplexing communication system shown in FIG. 9, the function of amplifying multiple-wavelength light in batch is required to each of the optical amplifiers 31. Also to improve the transmission quality in the wavelength division multiplexing communication, the plurality of optical amplifiers 31 must satisfy the requirement that the power difference between wavelengths of transmitted light is small after amplification.

To reduce the power difference between wavelengths of transmitted light, it has been proposed to provide a variable optical attenuator having the function to always make the multiple-wavelength light have a required level of power in each of the optical amplifiers 31.

The following conditions are required to this type of variable optical attenuator, (1) an optical attenuation rate for each wavelength is constant (in other words, the optical attenuation rate does not change or changes little for different wavelengths, (2) the optical attenuation rate of 30 dB or more can be achieved, (3) the variable optical attenuator can endure a high optical input power, and (4) the attenuator is compact, but the required conditions are not limited to those described above.

As an example of this type of variable optical attenuator having been put into practical use, there is the variable optical attenuator as shown in FIG. 10, and in this variable optical attenuator, a light-absorbing member 15 comprising a glass substrate 11 and a light-absorbing film 12 is provided in a light path for the light propagating between optical fibers 3 and 4 as optical components.

The glass substrate 11 is placed on the XY plain substantially to perpendicular to the Z axis assuming that optical axes of the optical fibers 3, 4 are in the Z-axial direction, and the light-absorbing film 12 is deposited on a top surface of the glass substrate 11. The light-absorbing film 12 has a prespecified film thickness distribution on the XY plain, and for instance, the thickness in the Z-axial direction gradually becomes larger in the X direction toward the right-hand side in the figure. Anti-reflection coats 13, 14 are provided on a top surface of the light-absorbing film 12 and a rear surface of the glass substrate 11 respectively.

In this variable optical attenuator, when the light-absorbing member 15 is moved in the X direction as indicated by the arrow A in FIG. 10, the thickness of the light-absorbing film 12 on the light paths of the optical fibers 3, 4 changes, and also the light attenuation rate changes.

FIG. 11A shows another example of variable optical attenuator. The variable optical attenuator shown in FIG. 11A has two Faraday rotators 16 provided on the light path. One of the Faraday rotators 16 has a birefrigent wedge plate 17 and a permanent magnet 18 provided in front of and at the back of the rotator in the direction of the light direction, while the other one of the Faraday rotators 16 has two pieces of electromagnet 19 provided in the two sides of the rotator in the direction perpendicular to the light path. A wavelength plate 20 is provided on the light path between one of the Faraday rotators 16 and the other one thereof.

This variable optical attenuator changes the magnetizing direction of the Faraday rotator 16 when a current loaded to the electromagnet 19 is changed, and accordingly changes the optical attenuation rate by making use of the Faraday effect.

FIG. 12A shows still another example of the variable optical attenuator. The variable optical attenuator shown in FIG. 12A has a straight shutter plate 21 provided on the light path of the optical fiber 3 and a mechanism for moving the shutter plate 21 (Refer to IEEE Journal of Selected Topics in Quantum Electronics, Vol. 5, No. 1, January/February 1999, pp 18-25). In this variable optical attenuator, the shutter plate 21 moves in the X-axial direction in the figure to change a quantity of light shuttered by the shutter plate 21, namely the light attenuation rate.

By the way, with the variable optical attenuator shown in FIG. 10, if it is tried to suppress a ratio of a quantity of outgoing light to a quantity of incident light, for instance, to 1/1000 or below, namely to obtain the optical attenuation rate of 30 dB or more, according to the conventional technology, width of the light-absorbing film 12 in the X-axial direction (Wx in the figure) is required to be about 1 cm or more. To move the light-absorbing member 15 in this variable optical attenuator, a moving means such as a motor is indispensable. Because of this necessity, minimization of the variable optical attenuator shown in FIG. 10 has been difficult.

In the variable optical attenuator shown in FIG. 10, there has also been the problem that, when a power of incident light is large, the light-absorbing film 12 is heated and the light-absorbing film 12 may be damaged if light with a power larger than the threshold value comes in.

On the other hand, in the variable optical attenuator shown in FIG. 11A, as indicated, for instance, by the characteristic lines a, b, c in FIG. 11B, dependency of the optical attenuation characteristics on wavelength is large, and even if a desired optical attenuation rate is obtained for a certain wavelength, sometimes a desired optical attenuation rate may not be obtained for a different wavelength, which is disadvantageous. In this figure, the characteristic line a indicates an optical attenuation rate for the wavelength of 1535 nm, the characteristics line b for the wavelength of 1549 nm, and the characteristics line c for the wavelength of 1565 nm respectively.

The variable optical attenuator shown in FIG. 11A requires an polarisor or an analizer not shown in the figure in addition to the electromagnet 19, Faraday rotator 16, and permanent magnet 18, so that the configuration is complicated and size reduction of the unit is also difficult.

Further the variable optical attenuator shown in FIG. 12A has the problem that the dependency of the optical attenuation characteristic on a wavelength is disadvantageously large as shown by the characteristic lines a, b in FIG. 12B.

Then characteristic line a in FIG. 12B shows the dependency of the optical attenuation characteristic on a wavelength when the shutter plate 21 is fixed at the position on the light path for the optical fiber 3 where light with the wavelength of 1500 nm is attenuated by 12.2 dB and the spectral distribution of light transmitted through the optical fiber 3 is measured in the wavelength range from 1500 to 1600 nm. As clearly shown by the characteristic line a, the maximum difference of about 0.8 dB in the optical attenuation is generated in the wavelength range from 1500 to 1600 nm.

The characteristic line b in FIG. 12 (b) indicates the dependency of the optical attenuation characteristic on a wavelength when the shutter plate 21 is fixed at the position where light with the wavelength of 1500 nm is attenuated by 13.5 dB like in the case described above. As clearly shown by the characteristic line b, the maximum difference of about 1 dB in optical attenuation rate is generated in the wavelength range from 1500 to 1600 nm.

As described above, when the optical attenuation rate becomes larger, the dependency of the optical attenuation characteristic becomes more remarkable in the variable optical attenuator shown in FIG. 12A. Because of this characteristics, when it is tried to obtain a ratio of a quantity of outgoing light to a quantity of incident light of 1/1000, namely to obtain the optical attenuation rate of 30 dB, its dependency on a wavelength becomes larger than that indicated by the characteristic line b, and resolution of the problem of dependency on a wavelength is required to put the optical attenuator as described above into practical use.

### SUMMARY OF THE INVENTION

It is an object of the present invention to provide a compact optical attenuator in which the dependency of optical attenuation rate on a wavelength is small, namely which can achieve the optical attenuation rate of, for instance, 30 dB or more and also can endure a high optical input power.

To achieve the object described above, the first aspect of the present invention provides a variable optical attenuator comprising one or more sheet of shutter plates positioned between optical components opposite to each other with a space therebetween and capable of shuttering at least a portion of light propagating between the optical components, and a moving means for moving the shutter plate in the direction crossing a light path for the light, in which at least one of the shutter plates has a form in its edge section adapted to reduction of the dependency of optical attenuation rate on a wavelength.

With the present invention, the dependency of optical attenuation rate of light propagating between the optical components on a wavelength can be reduced by using a shutter plate.

The above-described and other objects, features, and advantages of the present invention will further fully be understood from the following description based on the attached drawings.

### BRIEF DESCRIPTION OF THE DRAWINGS

FIG. 1 is a first embodiment of a variable optical attenuator according to the present invention;

FIG. 2A is a plan view showing the peripheral configuration of a substrate used in the variable optical attenuator shown in FIG. 1;

FIG. 2B is a side view shown in FIG. 2A;

FIG. 3A is a plan view showing the peripheral configuration of a substrate according to a second embodiment of the present invention;

FIG. 3B is a side view shown in FIG. 3A;

FIG. 4A and FIG. 4B are explanatory views each showing an example of a section of the variable optical attenuator according to the present invention in which a shutter plate is provided; FIG. 5A to FIG. 5C are model diagrams each showing an example in which a shutter plate is provided in the variable optical attenuator according to the present invention;

FIG. 5D is a model diagram showing a comparative example relating to a shutter plate;

FIG. 6 is a graph showing a result of calculation of the dependency of optical attenuation rate on a wavelength in each of the shutter plates shown in FIG. 5A to FIG. 5D;

FIG. 7A to FIG. 7C are graphs showing results of measurement of the dependency of optical attenuation rate with the shutter plates shown in FIG. 5A and FIG. 5C as well as with the shutter plate shown in FIG. 5D;

FIG. 8A to FIG. 8D are explanatory views each showing other configuration of a shutter plate in the variable optical attenuator according to the present invention;

FIG. 9 is a block diagram showing a wavelength division multiplexing communication system based on the conventional technology;

FIG. 10 is a block diagram showing one example of a variable optical attenuator based on the conventional technology;

FIG. 11A is a block diagram showing another example of the variable optical attenuator based on the conventional technology;

FIG. 11B is an explanatory view showing the dependency of optical attenuation rate on a wavelength in the variable attenuator shown in FIG. 11A;

FIG. 12A is a block diagram showing still another example of the variable optical attenuator based on the conventional technology; and

FIG. 12B is an explanatory view illustrating the dependency of optical attenuation rate on a wavelength in the variable optical attenuator shown in FIG. 12A.

### DETAILED DESCRIPTION

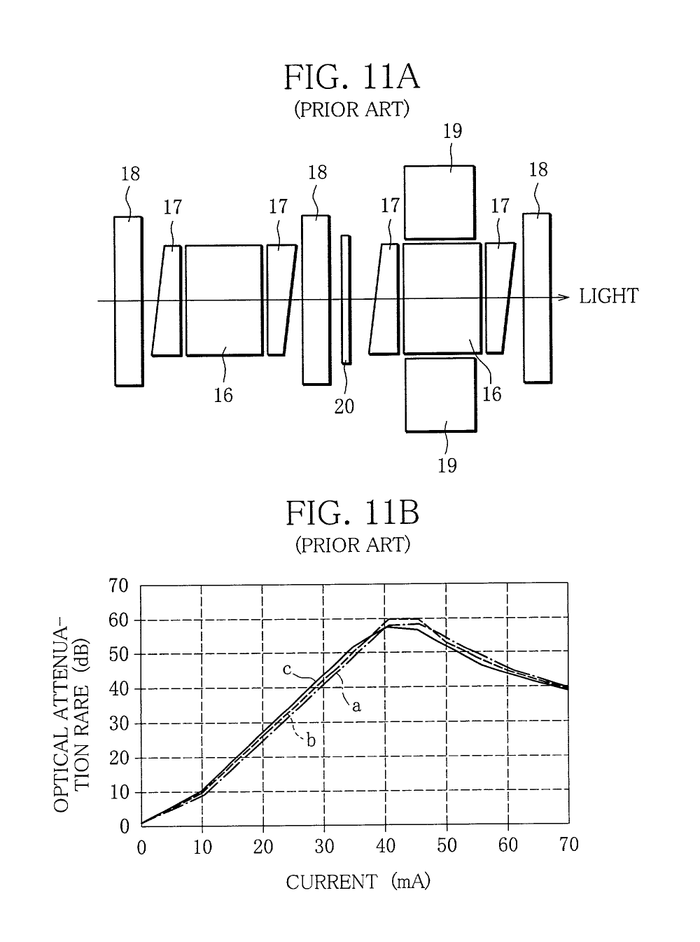

The conventional type of variable optical attenuator using a light-absorbing film or a Faraday rotator as shown in FIG. 10 or FIG. 11 A can not simultaneously satisfy at least three of the requirements 1) to 4) described above: (1) an optical attenuation rate for each wavelength is constant (in other words, the optical attenuation rate does not change or changes little for different wavelengths, (3) the variable optical attenuator can endure a high optical input power, and (4) the attenuator is compact.

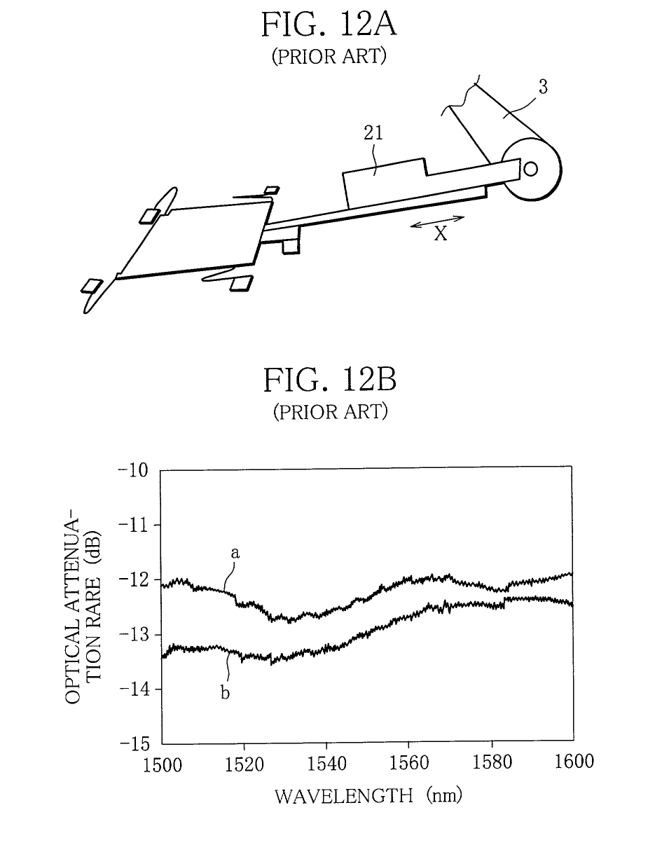

In contrast, the conventional type of variable optical attenuator shown in FIG. 12A can be made smaller as compared to the variable optical attenuator shown in FIG. 10 or FIG. 11A, because a shutter plate is used therein. This type of variable optical attenuator can not, however, the requirement 1) above as shown in FIG. 12B.

Therefore, as a new configuration capable of reduction of the dependency of optical attenuation rate on a wavelength, the present invention proposes use of a shutter plate which can satisfy the requirements above at a high level.

A variable optical attenuator provided in such an optical component as an optical amplifier for wavelength division multiplexing communication is generally located between optical fibers provided at a space therebetween. The present inventors considered that a cause for the dependency of optical attenuation rate on a wavelength was the dependency of a mode field diameter of an optical fiber on a wavelength. The dependency of a mode field diameter of an optical fiber on a wavelength means that the mode field diameter of propagating light becomes larger as the wavelength becomes longer, and that, on the contrary, the mode field diameter becomes smaller as the wavelength becomes smaller.

Because of this feature, when a portion of light propagating between optical fibers is shuttered by a shutter plate to achieve an appropriate optical attenuation rate (for instance about 30 dB to satisfy the requirement 2) above), if a wavelength of the propagating light is changed, also the mode field diameter of the optical fiber changes, which in turn causes a change in the optical attenuation rate.

It should be noted that, also in optical components other than an optical fiber, a mode field diameter of light propagating between optical components changes according to a wavelength of the light and also the optical attenuation rate changes.

Therefore, to remove the dependency of optical attenuation rate on a wavelength, principally it is required only to shutter, in response to a mode field of light generally having a circular form, light in an area having a fan form from a center of the mode field diameter. However, forming the configuration as described above in response to a mode field diameter of several μm is practically impossible.

To overcome this difficulty, the present inventors invented a configuration enabling reduction of the dependency of optical attenuation rate on a wavelength with simple configuration based on the studies as described below.

At first, the present inventors assumed that light propagating between optical fibers 3, 4 provided at a space therebetween is a Gaussian beam when plotted with the horizontal axis indicating a distance from the core and the vertical axis indicating a power of the light. A form of the mode field Fmo on a plane crossing at right angles the optical axes of the optical fibers 3, 4 is circular.

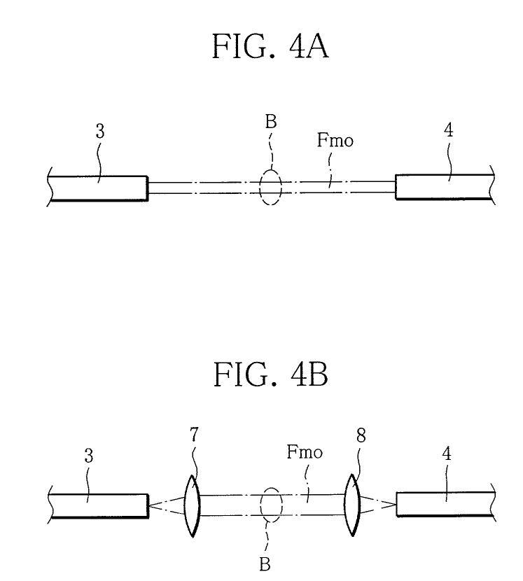

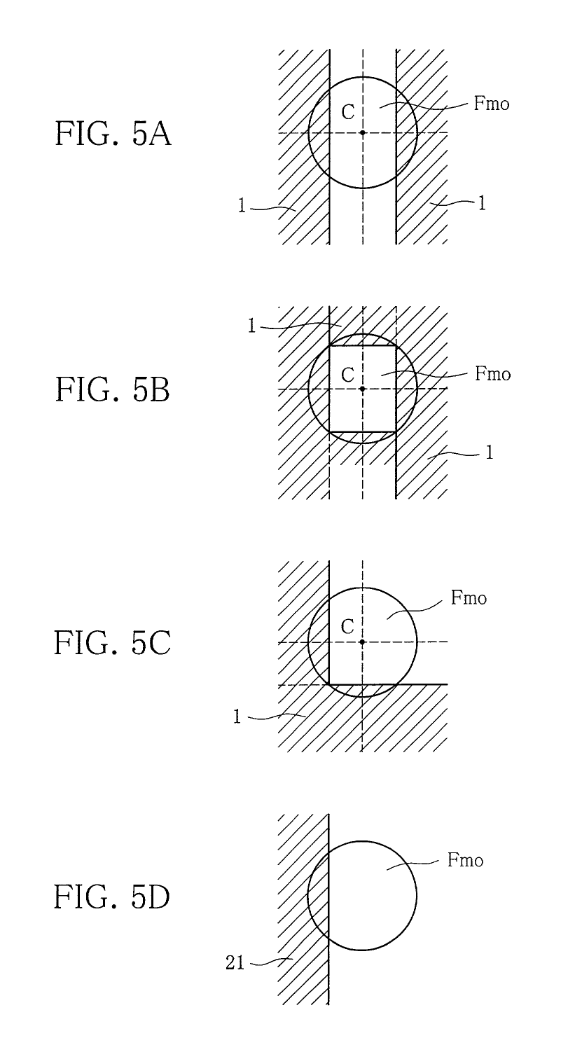

The shutter plate 1 is placed in an arrangement section B on the light path shown in FIG. 4A so that the shutter plate 1 cross the light path at right angles. A form and arrangement of the shutter 1 was set as shown by the models 1 to 3 shown in FIG. 5A to FIG. 5C respectively. Each form and arrangement were studied by executing simulations based on the assumption described above for the dependency of optical attenuation rate on a wavelength between the optical fibers 3, 4 in the wavelength range from 1530 to 1580 nm.

The same study was performed also for the more shown in FIG. 5D (the variable optical attenuator shown in FIG. 12A) as a comparative example.

FIG. 5A shows a case where two sheets of shutter plates 1 are provided holding a central section C of the light path (a center of the mode field Fmo of light described above) from both sides thereof (model 1). FIG. 5B shows a case where two sheets of shutter plates 1 each having a V-shaped notched section (an angle of the V herein is 90 degrees) are provided (model 2). It should be noted that, in the case of model 2, four sheets of shutter plates 1 may be placed around the central section C of the light path. FIG. 5C shows a case where one shutter plate 1 having a V-shaped notched section (an angle of the V herein is 90 degrees) is provided (model 3). It should be noted that, in the case of model 3, two sheets of shutter plates 1 may be provided around the central section of the light path.

In the drawings referred to in the following description, a mode field of light is indicated by the sign Fmo.

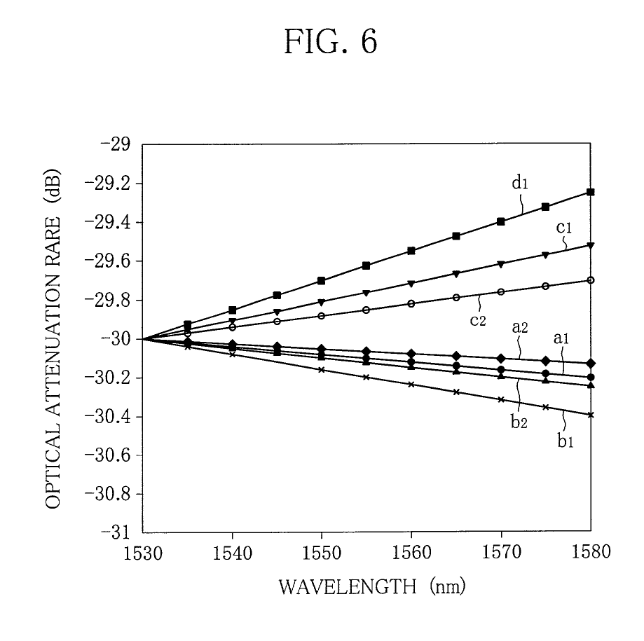

A result of simulation performed with the models 1 to 3 and the comparative example above is shown in FIG. 6. In FIG. 6, the characteristic line al indicates characteristics of model 1, the characteristic line b1 those of model 2, characteristic line cl those of model 3, and characteristic line d those of the comparative example respectively.

Table 1 shows differences between an optical attenuation rate for the wavelength of 1530 nm and that for the wavelength of 1580 nm calculated based on a result of the simulation performed assuming the optical attenuation rate for the wavelength of 1530 nm as the reference (0). It should be noted that a value with the sign of minus (−) indicates that the optical attenuation rate becomes larger as the wavelength becomes longer.

TABLE 1

| | | | | Comparative |
|---|---|---|---|---|
| | Model 1 | Model 2 | Model 3 | example |
| | (FIG. 5A) | (FIG. 5B) | (FIG. 5C) | (FIG. 5D) |
| Difference of | −0.183 | −0.365 | 0.498 | 0.768 |
| optical | | | | |
| attenuation | | | | |
| rate (dB) | | | | |

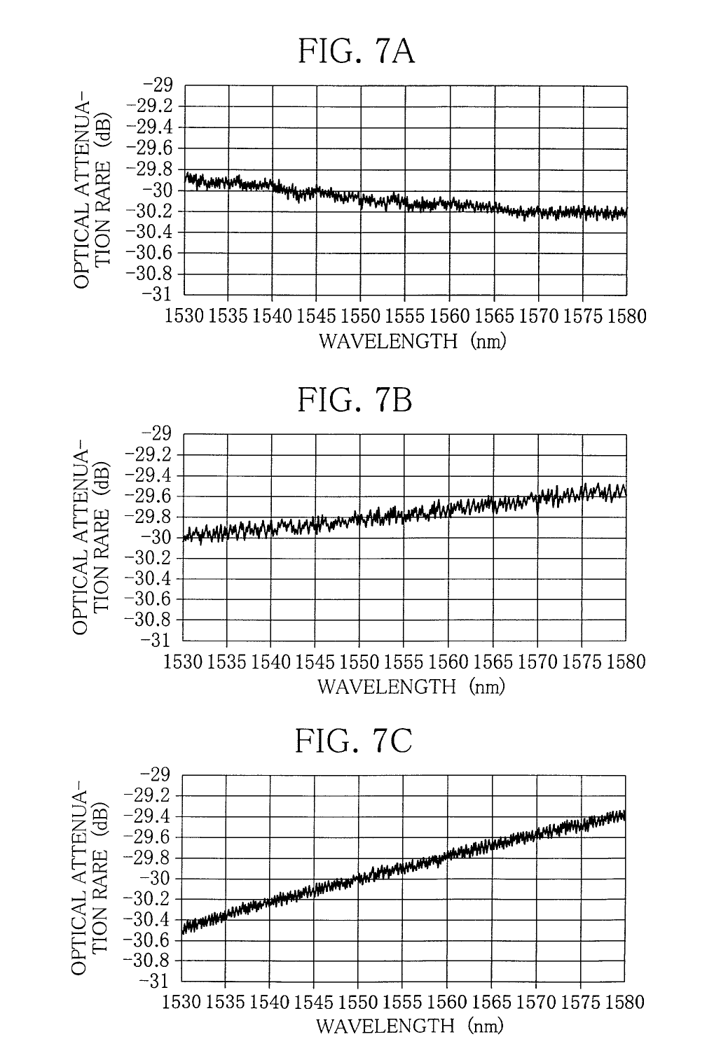

Further results of measurement of the dependency of optical attenuation rate on a wavelength in the models 1, 3 shown in FIG. 5A and FIG. 5C are shown in FIG. 7A and FIG. 7B respectively, and a result of measurement of the dependency of optical attenuation rate on a wavelength in the comparative example shown in FIG. 5D is shown in FIG. 7C.

As clearly shown in Table 1, FIG. 6, and FIGS. 7A to 7C, any of the models 1 to 3 can reduce the dependency of optical attenuation rate on a wavelength by about 0.3 dB or more as compared to the comparative example (in the case of the variable optical attenuator shown in FIG. 12A). Namely, with the configuration shown in the models 1 to 3, it is possible to provide a compact variable optical attenuation which can reduce the dependency of optical attenuation rate on a wavelength even if an amplitude of light is attenuated by 30 dB or more as shown in FIGS. 7A and 7B and also which can endure a high optical input power.

On the other hand, in the second aspect of the present invention, at least either one of a notched section and a protrusion is formed in a shuttering edge section of a shutter plate based on a result of the studies described above. Therefore, in the variable optical attenuator according to the second aspect of the present invention, the shutter plate with, for instance, a V-shaped notched section or a protrusion shutters light so that the dependency of optical attenuation rate on a wavelength associated with a change in a mode field diameter in an optical component such as an optical fiber is reduced, and because of this feature the dependency of optical attenuation rate on a wavelength can be controlled in this variable optical attenuator.

When the notched section has the V-shaped form as described above or the protrusion is polygonal, the shutter plate can be manufactured more easily, and control over the dependency of optical attenuation rate on a wavelength can be performed more efficiently.

In the third aspect of the present invention, based on the result of study described above, a plurality of shutter plates are provided on a plain crossing a light path for light propagating between the optical components so that the shutter plates hold a central section of the light path therebetween or surround it. Therefore, in the variable optical attenuator according to the third aspect of the present invention, the plurality of shutter plates, for instance, arranged as shown in the models 1 to 3 shutter light so that the dependency of optical attenuation rate on a wavelength association with a change in a mode field diameter caused on the dependency of optical components on a wavelength is reduced, and accordingly the dependency of optical attenuation rate on a wavelength can be controlled.

On the other hand, as shown in FIG. 4B, lenses 7, 8 which enlarge a mode field diameter of light and convert the light into a parallel beam are provided between the optical fibers 3, 4 (in the thirteenth and fourteenth aspects of the present invention). It has turned out that, in this case, the dependency of optical attenuation rate on a wavelength can further be reduced as shown by the characteristic lines a2 to c2 in FIG. 6 and in Table 2. In FIG. 6, the characteristic lines a2, b2, and c2 indicates characteristics of the models 1, 2, and 3 respectively.

TABLE 2

| | Model 1 | Model 2 | Model 3 |
|---|---|---|---|
| | (FIG. 5A) | (FIG. 5B) | (FIG. 5C) |
| Difference of | −0.119 | −0.234 | 0.318 |
| optical attenuation | | | |
| rate (dB) | | | |

Therefore, as the lenses for expanding a mode field diameter of light and converting the light into a parallel beam are provided in the incidence side of each shutter plate, in the variable optical attenuator according to the thirteenth and fourteenth aspects of the present invention, the dependency of optical attenuation rate on a wavelength can further be reduced.

Further the variable optical attenuator according to the present invention comprises, in addition to the components in the second and third aspects of the present invention as described above, one or more sheets of shutter plates each provided between optical components at opposite positions with a space therebetween and shuttering at least a portion of light propagating between the optical components above and a moving means for moving the shutter plate in a direction crossing a light path for the light, and an edge section of at least one of the shutter plates has a form adapted to reduction of the dependency of optical attenuation rate on a wavelength.

Therefore, the variable optical attenuator according to the present invention can reduce the dependency of optical attenuation rate of light propagating between optical components on a wavelength when an edge of the shutter plate has an appropriate form or a plurality of shutter plates are arranged at appropriate positions.

Embodiment 1

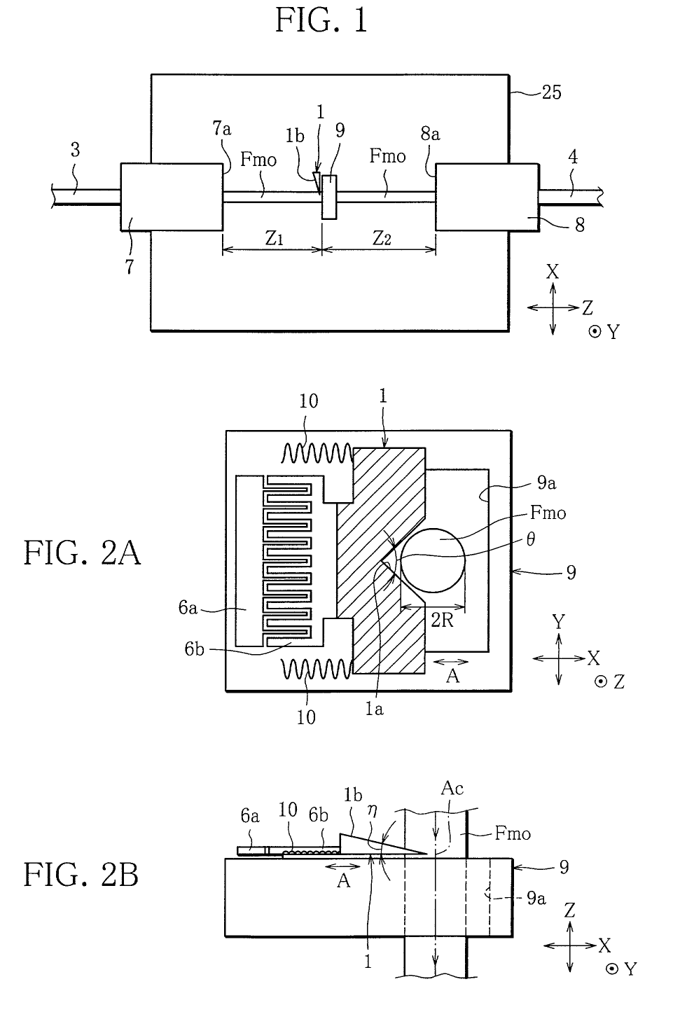

FIG. 1, FIG. 2A, and FIG. 2B simulatively shows configuration of a key section in a first embodiment of the variable optical attenuator (hereinafter referred to as “VOA”) according to the present invention. As shown in FIG. 1, the VOA according to this embodiment comprises a housing 25 provided between the optical fibers 3, 4 which are optical components arranged at opposite positions with a space therebetween, lenses 7, 8 attached to the housing 25, and a silicon substrate 9 provided in the housing 25. The substrate 9 and lenses 7,8 are arranged at spaces from the optical fibers 3, 4 in the light-axial direction respectively.

As shown in FIG. 2A and FIG. 2B, a through hole 9a is formed in the substrate 9. The substrate 9 has the shutter plate 1, on its top surface, which can freely slide against the substrate surface.

The shutter plate 1 is supported by a spring 10 as shown in FIG. 2A and FIG. 2B so that it can freely move in the X-axial direction. The shutter plate 1 shutters at least a portion of light propagating between the optical fibers 3, 4, and a notched section la having a V-shaped form is formed at the edge section. In the notched section 1a, the angle θ of the V-shaped section's tip (Refer to FIG. 2A) is set to 90 degrees.

Further a shuttering face 1b in the incidence side of the shutter plate 1 has a wedge-shaped form inclined against a central axis Ac of light to be shuttered, and a gold thin film 1c is deposited on the section shown by the inclined lines of the shuttering face 1b. Herein, in the substrate 1, the angle η shown in FIG. 2B is set to 15 degrees, and an angle between the shuttering face 1b and the central axis Ac of the light to be shuttered is 75 degrees. In this embodiment, by inclining the shuttering face 1b of the shutter place 1 so that the angle between the shuttering face 1b and the central axis Ac of the light to be shuttered is not less than 45 degrees and less than 90 degrees, the bad effect caused by light returning to the incidence side (optical fiber 3) can be prevented.

Further a shutter plate moving means for moving the shutter plate 1 in the direction indicated by the arrow mark A which is parallel to the X-axial direction crossing the light path for the light is provided on the substrate 9, and this moving means has a comb drive 6a which is an electrostatic driving circuit having a form like comb teeth from by etching silicon, comb teeth 6b, and a spring 10 (Refer to, for instance, SPIE Vol. 3878,1999, P.39-47). The comb drive 6a is opposite to the comb teeth 6b formed in the contrary side from the shuttering edge section of the shutter plate 1, and moves the shutter plate 1 with an electrostatic force.

The shutter plate 1, comb drive 6a as a moving means, comb teeth 6b, and spring 10 are formed by the semiconductor fine manufacturing technology on the substrate 9, and the size of the substrate 9 is 2 mm in the X and Y-axial directions, and 0.5 mm in the Z-axial direction.

The lens 7 shown in FIG. 1 is provided in the incidence side of the shutter plate 1, and enlarges a mode field diameter of the light going out of the optical fiber 3, converts the light to a parallel beam, and introduces the light to the shutter plate 1. The lens 8 is provided in the light-outgoing side of the shutter plate 1, and has the same configuration as the lens 7. The lenses 7, 8 are collimate lenses each having the focal distance of 1.81 mm, and a space z1 between an edge face 7a of the lens 7 and the shuttering face 1b and a space z2 between the shuttering face 1b and an edge face 8a of the lens 8 are set to about 15 mm respectively. The lens 7 causes the light emitted from the optical fiber 3 to fall upon the shutter plate 1 while converting the light to a parallel beam with a mode field diameter (2R in FIG. 2A) thereof enlarged to about 100 μm.

The VOA according to this embodiment has the configuration as described above, and when the comb drive 6a is driven, the shutter plate 1 moves because of an electrostatic force in the X-axial direction in the figure, and light propagating from the optical fiber 3 via the lens 7 to the optical fiber 4 is shuttered by the shutter plate 1.

This state is the same as that of the model 3 shown in FIG. 5C. The VOA according to this embodiment can attenuates light by 30 dB or more between the optical fibers 3, 4, and the dependency of optical attenuation rate on a wavelength in the wavelength range from 1530 nm to 1580 nm can be made substantially smaller as compared to that of the conventional VOA shown in FIG. 12A.

For instance, when the shutter plate 1 is moved to a position where the optical attenuation rate for the wavelength of 1530 nm is 30 dB, the difference between the maximum value and the minimum value of optical attenuation rate in the wavelength range from 1530 nm to 1580 nm is 0.318 dB when numerically computed for the model 3 in Table 2, and the difference is very small. As clearly understood from comparison to the difference in the optical attenuation rate (0.768 dB) in the comparative example shown in Table 1, the VOA according to this embodiment can reduce the difference in optical attenuation rate by 0.45 dB or more as compared to that in the conventional type of VOA shown in FIG. 12A.

The effect of reducing the dependency of an optical attenuation rate on a wavelength in the VOA according to this embodiment is more clearly understood from comparison of a result of the experiment shown in FIG. 7B to a result of the experiment for comparative example shown in FIG. 7C indicating that an inclination of a line plotted for optical attenuation rate/wavelength shown in FIG. 7B is smaller than that in FIG. 7C.

Therefore, the VOA according to this embodiment can be used as a VOA for an optical amplifier for wavelength division multiplexing communication which can substantially control multiple-wavelength light at a desired power level in batch.

In addition, the VOA according to this embodiment has very simple configuration comprising the shutter plate 1, comb drive 6a, comb teeth 6b, and spring 10 each formed by using the semiconductor fine engineering technology and provided on the substrate 9, and the size is very small, so that the VOA can be used as a compact VOA which can effectively control an optical attenuation rate.

Embodiment 2

A second embodiment of the VOA according to the present invention is described below. In the following description, the same reference numerals are assigned to the same components as those in the embodiment 1 described above, and duplicated descriptions are omitted herefrom.

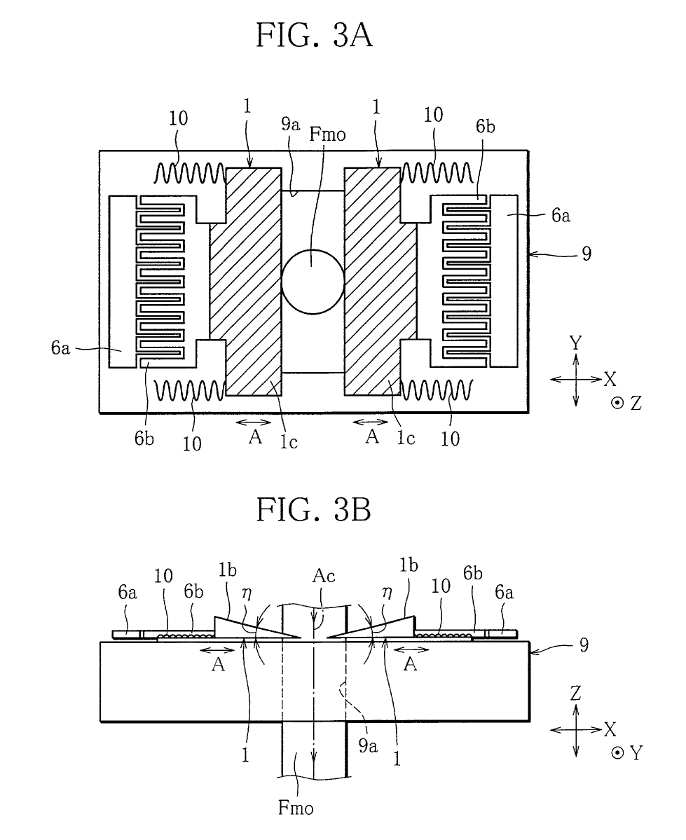

The VOA according to the embodiment 2 comprises, like in the VOA according to the embodiment 1, the housing 25, silicon substrate 9, and lenses 7, 8 shown in FIG. 1, and peripheral configuration of the substrate 9 is shown in FIG. 3A and FIG. 3B.

The VOA according to the embodiment 2 comprises a plurality (two sheets, herein) of shutter plates 1 arranged, on a plain crossing a light path for light propagating between the optical fibers 3, 4 provided at a space therebetween so that the shutter plates 1 hold a central section of the light path, and the spring 10 as a moving means for moving the shutter plates 1 in a direction crossing the light path.

In the VOA according to the embodiment 2, configuration of the spring 10 is the same as that in the embodiment 1. Although the VOA according to the embodiment 2 have not have the notched section 1a like that in the shutter plate 1 according to the embodiment 1, configuration of other portions of the shutter plate 1 is the same as that in the embodiment 2. It should be noted that the shuttering faces 1b of the two shutter plates 1 incline in directions opposite to each other.

Configuration of the VOA according to the embodiment 2 is as described above, and like in the VOA according to the embodiment 1, the shutter plate 1 is moved in the X-axial direction as indicated by the arrow A in the figure when driven by the comb drive 6a. The light propagating from the optical fiber 3 via the lens 7 to the shutter plate 1 is shuttered by the shutter plate 1, and thus the VOA according to the embodiment 2 achieves the substantially same effect as that provided by the VOA according to the embodiment 1.

The shuttering state by the VOA according to the embodiment 2 is the same as that by the model 1 shown in FIG. 5A. For instance, when the shutter plate 1 is moved to a position where the optical attenuation rate is 30 dB for the wavelength of 1530 nm, the difference between the maximum value and minimum value in the optical attenuation rate in the wavelength range from 1530 nm to 1580 nm is 0.119 dB when computed for the model 1 shown in Table 2, so that the VOA according to the embodiment 2 can reduce the dependency of an optical attenuation rate on a wavelength more than that in the VOA according to the embodiment 1.

The effect of reducing the dependency of an optical attenuation rate on a wavelength in the VOA according to the embodiment 2 can clearly be understood from comparison of the test result shown in FIG. 7A to that shown in FIG. 7C.

The VOA according to the present invention are not limited to those described above, and various variants are possible. For instance, In the VOA according to the embodiment 1, the V-shaped notched section 1a is formed in a shuttering edge section of the shutter plate 1 and the angle of V is 90 degrees, but there is not any specific restriction over this angle, and the angle may be set to any appropriate value. If the angle of V is more than 90 degrees, a form of the notched section 1a becomes like a mode field even when a movement rate of the shutter plate 1 is zero. In this case, a large optical attenuation rate can not be achieved, even if a moving amount of the shutter plate 1 is small.

In the VOA according to the embodiment 1, the V-shaped notched section 1a is formed in a shuttering edge section of the shutter plate 1, but a form of the notched section 1a is not always required to be V-shaped, and any shape is allowable so long as the dependency of an optical attenuation rate on a wavelength can be reduced in the VOA. When a form of the notched section 1a is a V-shaped one, it is easy to manufacture the shutter plate 1, and in addition, the effect of reducing the dependency of an optical attenuation rate on a wavelength in the VOA can be reduced without fail as described in the embodiment 1 and in relation to the model 3.

Although the VOA according to the embodiment 2 does not have the notched section 1a formed in a shuttering edge section of the shutter plate 1, the notched section 1a may be formed at edge sections of a plurality of shutter plates 1 respectively. Further, when a plurality of shutter plates 1 are provided, there is no specific restriction over the number and arrangement form, and the shutter plates 1a may be arranged in any form according to the necessity.

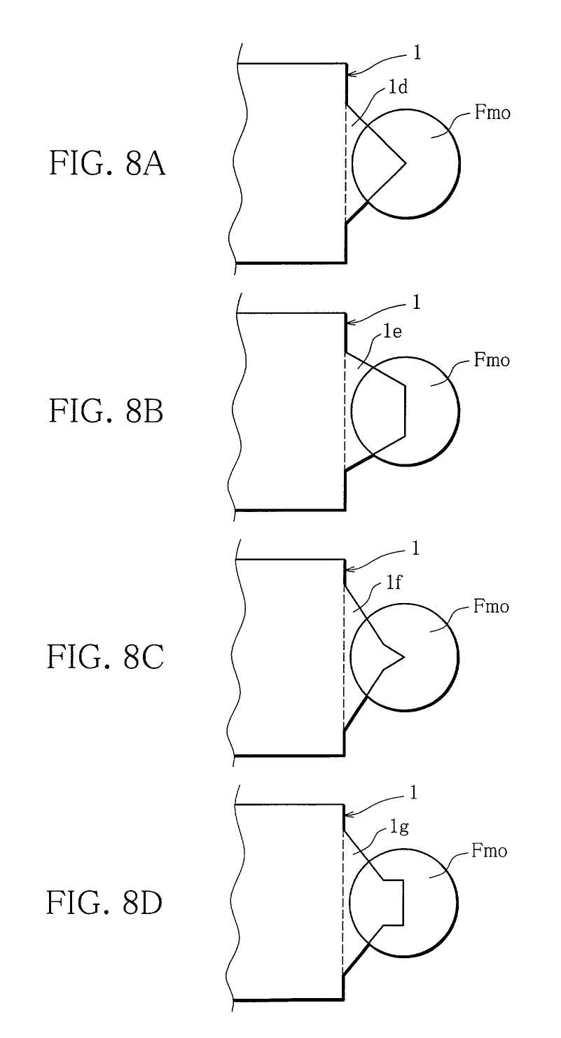

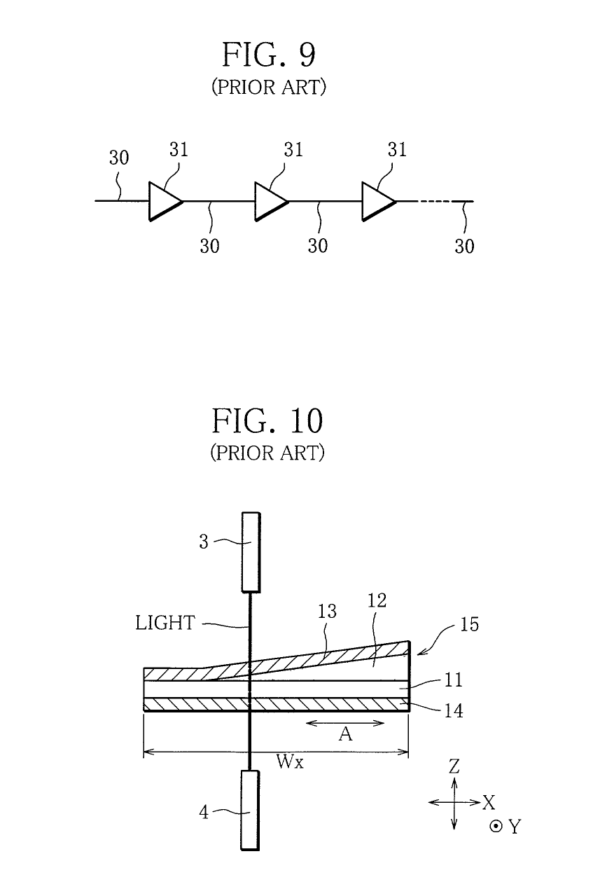

On the other hand, the VOA according to the present invention may have the configuration in which a protrusion is provided at an edge section of the shutter plate 1. In this case, a form of the protrusion is a polygonal one including a triangular form like the protrusion 1d shown in FIG. 8A, a square form like the protrusion 1e shown in FIG. 8B, a pentagonal one like the protrusion If shown in FIG. 8C, or a hexagonal one like the protrusion 1g shown in FIG. 8D. When this condition is satisfied, each of the protrusions 1d to 1g on the shutter plate 1 can easily be machined, and further the shutter plate 1 can fully achieve the effect of reducing the dependency of an optical attenuation rate on a wavelength to its full extent.

In addition, both of any of the protrusions 1d to 1g and the notched section 1a may be formed at a shuttering edge section of the shutter plate 1.

In each of the embodiments described above, the means for moving the shutter plate 1 uses a electrostatic force to move the shutter plate 1. However, an electromagnetic driving system is also allowable in which a micro-electromagnet is formed, for instance, by means of the semiconductor fine engineering technology such as electromagnetic film deposition and etching and the shutter plate 1 is moved by a electromagnetic force.

In each of the embodiments described above, the shuttering face 1b of the shutter plate 1 inclines toward a central axis Ac of the light to be shuttered, and the angle η shown in FIG. 1 and FIG. 2 is set to 15 degrees. But, so long as the shuttering face 1b of the shutter plate 1 is inclined so that its angle against the central axis Ac of the light to be shuttered is more than 45 degrees and less than 90 degrees, the bad effect caused by reflection of light to the incidence side (to the optical fiber 3) can be prevented without fail.

In each of the embodiments described above, a mode field diameter of light emitted from the optical fiber 3 is enlarged to about 100 μm by the lens 7, but there is no specific restriction over a value of a mode field diameter enlarged by the lens 7, and the mode field diameter may be set to any value according to the necessity.

The lenses 7, 8 may be omitted from the VOA according to the present invention. It is preferable to provide lenses, however, because a mode field diameter of light can be made larger than a mode field diameter of the optical fiber 3 by providing lenses, which in turn makes it possible to reduce the dependency of an optical attenuation rate on a wavelength.

In the VOA according to the present invention, it is not always required to provide the shutter plate 1 between the optical fibers 3 and 4, and the shutter plate 1 may be provided between optical components other than optical fibers which are provided at opposite positions with a space therebetween.

What is claimed is:

1. A variable optical attenuator comprising:
one or more sheets of shutter plates provided between optical components provided at opposite positions with a space therebetween and shuttering at least a portion of light propagating between said optical components; and
a moving means for moving said shutter plate in a direction crossing a light path for the light,
wherein an edge section of said at least one shutter plate has a form adapted for reducing the dependency of an optical attenuation rate on a wavelength.

2. The variable optical attenuator of claim 1,
wherein said shutter plate has at least either one of a notched section and a protrusion each formed at an edge section thereof and effective for reducing the dependency of an optical attenuation rate on a wavelength.

3. The variable optical attenuator of claim 1,
wherein a plurality of said shutter plates are provided on a plane crossing a light path for light propagating between optical components provided at opposite positions with a space therebetween, so that the shutter plates hold therebetween or surround a central section of the light path, and an edge section of each of said plurality of shutter plates has a straight form.

4. The variable optical attenuator of claim 3,
wherein said plurality of shutter plates have at least either one of a notched section or a protrusion formed at the edge section and effective for reducing the dependency of an optical attenuation rate on a wavelength.

5. The variable optical attenuator of claim 2,
wherein said notched section has a V-shaped form.

6. The variable optical attenuator of claim 4,
wherein said notched section has a V-shaped form.

7. The variable optical attenuator of claim 5,
wherein said notched section has a V-shaped angle of 90 degrees or more.

8. The variable optical attenuator of claim 6,
wherein said notched section has a V-shaped angle of 90 degrees or more.

9. The variable optical attenuator of claim 2,
wherein said protrusion has a polygonal form.

10. The variable optical attenuator of claim 4, wherein said protrusion has a polygonal form.

11. The variable optical attenuator of claim 1,
wherein a shuttering face of said shutter plate is inclined toward a central axis of light to be shuttered and an angle between said shuttering face and a central shaft of light is set to a value from more than 45 degrees to less than 90 degrees.

12. The variable optical attenuator of claim 2,
wherein a shuttering face of said shutter plate is inclined toward a central axis of light to be shuttered and an angle between said shuttering face and a central shaft of light is set to a value from more than 45 degrees to less than 90 degrees.

13. The variable optical attenuator of claim 1,
wherein said shutter plate has a lens for enlarging a mode field diameter of light provided in the incidence side.

14. The variable optical attenuator of claim 2,
wherein a lens for enlarging a mode field diameter of light is provided in the incidence side.

15. The variable optical attenuator of claim 1,
wherein said shutter plate and said moving means are formed on a substrate by using the semiconductor fine engineering technology.

16. The variable optical attenuator of claim 2,
wherein said shutter plate and said moving means are formed on a substrate by using the semiconductor fine engineering technology.

17. The variable optical attenuator of claim 1,
wherein said moving means moves said shutter plate with at least either one of an electrostatic force and an electromagnetic force.

18. The variable optical attenuator of claim 2,
wherein said moving means moves said shutter plate with at least either one of an electrostatic force and an electromagnetic force.

19. The variable optical attenuator of claim 1,
wherein an optical attenuation rate of light propagating between said optical components in the wavelength range from 1530 nm to 1580 nm is set to a value from 0 dB to 50 dB.

20. The variable optical attenuator of claim 2,
wherein an optical attenuation rate of light propagating between said optical components in the wavelength range from 1530 nm to 1580 nm is set to a value from 0 dB to 50 dB.
